(19) United States
(12) Patent Application Publication
(10) Pub. No.: US 2006/0262983 A1
(43) Pub. Date: Nov. 23, 2006

(54) Method and apparatus for selecting intra prediction mode

(76) Inventors: Chao-chung Cheng, Hsinchu (TW); Tian-sheuan Chang, Hsinchu (TW); Chi-ken Tsai, Hsinchu (TW)

Correspondence Address: MARTINE PENILLA & GENCARELLA, LLP, 710 LAKEWAY DRIVE, SUITE 200, SUNNYVALE, CA, 94085, US

(21) Appl. No.: 11/431,769

(22) Filed: May 9, 2006

(30) Foreign Application Priority Data
May 17, 2005 (TW) 94115963

(51) Int. Cl. G06K 9/36

(52) U.S. Cl. 382/238

(57) ABSTRACT

A method for selecting intra prediction mode includes: calculating an error value for each of the prediction modes in a first group, wherein the first group includes two prediction modes where an included angle between their prediction directions is the largest; calculating an error value for each of the prediction modes in a second group, wherein the prediction modes in the second group refer to the prediction modes with prediction directions near the two sides of the prediction direction of the prediction mode with smaller error value in the first group; calculating an error value for the prediction mode in a third group, wherein the prediction mode in the third group is the prediction mode with prediction direction adjacent to the prediction direction of the prediction mode with smaller error value in the second group; calculating a DC prediction mode in the plurality of prediction modes; and among the prediction modes with calculated error values, selecting a prediction mode with a smallest error value to be the intra prediction mode for encoding the subblock.

### BACKGROUND OF THE INVENTION

(a) Field of the Invention

The invention relates to a method and an apparatus for selecting intra prediction mode and, more particularly, to a method and an apparatus for selecting intra prediction mode by using a relatively small computation load.

(b) Description of Related Art

Due to the fast advancement in information technology, sounds and images can be stored and played in digital format, and therefore the applications of video/audio information are greatly expanded. However, if the video/audio information is fully stored without being processed at all, an extremely large storage space would be needed, especially for storing video information that records images; it would disadvantage subsequent storage and transmission of the video/audio files. There have been many video-encoding technologies developed to solve the problem of over-sized video files, and the technologies are able to effectively compress the size of video files and maintain the original picture quality during playback, or maintain the distortion level of picture quality within an acceptable range during playback.

The principle of video encoding is briefly explained below. In order to get a better compression efficiency, the encoding of a series of video frames is divided into two parts: the first part is called intra-coding, which is the encoding method for a single video frame; and the second part is called inter-coding, which is a video frame reconstruction method using the preceding and following video frames to predict the current video frame.

The video encoding standard H.264/AVC (MPEG-4 Part 10 Advanced Video Coding) set by ITU-T and ISO/IEC is used as an example to described the intra-coding method. In H.264/AVC video encoding standard, a video frame is divided into a plurality of macroblocks, and each macroblock is composed of 16×16 pixels. Each macroblock is further divided into 4×4 subblocks, and hence each subblock is composed of 4×4 pixels. Intra-coding uses the values of reference pixels near a subblock to predict the values of the pixels in the subblock. As shown in FIG. 1, a subblock 1 defined by bold lines is composed of pixels a to p. The values of pixels a to p are replaced after the computations of all or partial of the values of reference pixels A to M.

Referring to FIG. 2, nine prediction modes, mode 0 to mode 8, are defined by H.264/AVC, wherein mode 2 is to replace pixels a to p with the average value of pixels A, B, C, D, I, J, K, and L, and is called a DC prediction mode. The prediction directions of the remaining eight prediction modes are as shown by arrows 2, which are respectively a vertical prediction mode, a horizontal prediction mode, and six diagonal prediction modes. FIG. 3 is a schematic diagram of multiple prediction directions being integrated. Take mode 0 as an example, the values of pixels a, e, i, and m are replaced by the value of pixel A as their predicted values, the values of pixels b, f, j, and n are replaced by the value of pixel B as their predicted values, and so on. Thus, errors occur between the predicted values of pixels in the subblock 1 and the original values of pixels in the subblock 1, and the sum of the absolute values of the differences between the predicted values of pixels in the subblock 1 and their original values is the error value obtained by encoding the subblock 1 with mode 0 as the prediction mode. Hence, the same subblock is encoded by nine prediction modes respectively to obtain nine error values.

To obtain video frames with minimized distortion level, namely, the biggest peak signal to noise ratio (PSNR), all of the nine prediction modes must be examined and the mode with a smallest error value is selected to be the prediction mode to process the subblock. It is foreseeable that a large computation load is indispensable for deciding which prediction mode to use for the prediction of each subblock. Therefore, how to effectively reduce the number of computations and quickly select a preferred prediction mode for every subblock while maintaining the picture quality close to optimized video frames is a goal to achieve at the present.

### SUMMARY OF THE INVENTION

In view of the aforementioned problems, an object of the invention is to provide a method and an apparatus for selecting intra prediction mode that are able to reduce the number of computations required for selecting a preferred prediction mode for a single subblock, and at the same time maintains the picture quality that is close to optimized video frames.

To achieve the aforementioned object, a method for selecting intra prediction mode of the invention is applied in a video encoding method. The video encoding method encodes a video data stream and defines a plurality of prediction modes, and the video data includes a plurality of video frame streams, wherein the video frame is composed of a plurality of subblocks. The method for selecting intra prediction mode includes steps of: calculating an error value for each of the prediction modes in a first group, wherein the first group includes two prediction modes with an included angle (the smaller one of the two complementary included angles) between their prediction directions being the largest; calculating an error value for each of the prediction modes in a second group, wherein the prediction modes in the second group refer to the prediction modes with prediction directions near the two sides of the prediction direction of the prediction mode with smaller error value in the first group; calculating an error value for the prediction mode in a third group, wherein the prediction mode in the third group refers to the prediction mode with prediction direction adjacent to the prediction direction of the prediction mode with smaller error value in the second group; calculating an error value for a DC prediction mode in the plurality of prediction modes; and selecting a prediction mode with a smallest error value among the DC prediction mode, the prediction modes in the first group, the prediction modes in the second group, and the prediction mode in the third group, to be the intra prediction mode for encoding the subblock.

An apparatus for selecting intra prediction mode of the invention is for executing the aforementioned method, the apparatus includes an error computation unit and a selection unit. The error computation unit first calculates an error value for each of the prediction modes in a first group, an error value for each of the prediction modes in a second group, and an error value for the prediction mode in a third group, wherein the first group includes two prediction modes which have an included angle (the smaller one of the two complementary included angles) between their prediction directions being the largest, the prediction modes in the second group refer to the prediction modes with prediction directions near the two sides of the prediction direction of the prediction mode with smaller error value in the first group, and the prediction mode in the third group refers to the prediction mode with prediction direction adjacent to the prediction direction of the prediction mode with smaller error value in the second group. Moreover, the error computation unit calculates an error value for a DC prediction mode in the plurality of prediction modes. The selection unit is connected to the error computation unit via signals, and according to the computation results of the error computation unit, selects a prediction mode with a smallest error value among the DC prediction mode, the prediction modes in the first group, the prediction modes in the second group, and the prediction mode in the third group, to be the intra prediction mode for encoding the subblock.

According to the method and apparatus for selecting intra prediction mode of the invention, the number of computations can be reduced significantly and the computation load can be lowered. Furthermore, the picture quality of encoded frames is close to the picture quality of frames encoded by conventional optimization.

### BRIEF DESCRIPTION OF THE DRAWINGS

FIG. 1 is a schematic diagram illustrating a conventional subblock and reference pixels.

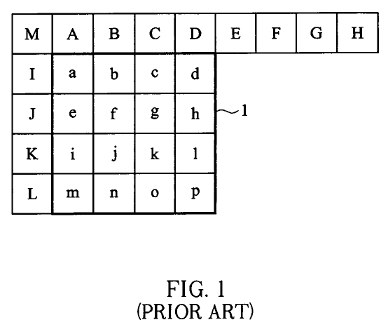

FIG. 2 is a schematic diagram illustrating nine prediction modes defined by a video encoding method under H.264/AVC video encoding standard.

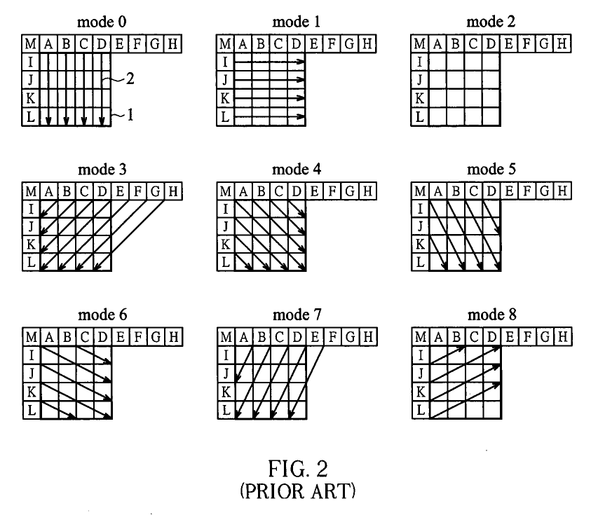

FIG. 3 is a schematic diagram illustrating prediction directions of eight prediction modes in FIG. 2.

FIG. 4 is a flow chart illustrating a method for selecting intra prediction mode according to a preferred embodiment of the invention.

FIG. 5 is a flow chart illustrating an application of a method for selecting intra prediction mode of the invention using a video encoding method under H.264/AVC video encoding standard as an example.

FIG. 6 is a flow chart illustrating another application of a method for selecting intra prediction mode of the invention using a video encoding method under H.264/AVC video encoding standard as an example.

FIG. 7 is a schematic diagram illustrating an apparatus for selecting intra prediction code according to a preferred embodiment of the invention.

### DETAILED DESCRIPTION OF THE INVENTION

The method and apparatus for selecting intra prediction mode according to preferred embodiments of the invention will be described below with reference to the drawings, wherein the like reference numerals denote the like components.

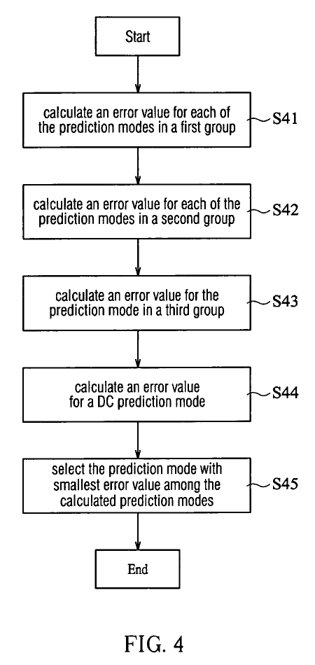

Referring to FIG. 4, a preferred embodiment of the method for selecting intra prediction mode of the invention, which is applied in a video encoding method, is shown. The video encoding method encodes a video data stream that includes a plurality of video frame streams, and the video frame is composed of a plurality of subblocks. The video encoding method also defines a plurality of prediction modes such as a DC prediction mode, a vertical prediction mode, a horizontal prediction mode, and six diagonal prediction modes.

A method for selecting intra prediction mode according to a preferred embodiment of the invention includes the following steps: calculating an error value for each of the prediction modes in a first group (S41), wherein the first group includes two prediction modes with an included angle (the smaller one of the two complementary included angles) between their prediction directions being the largest; calculating an error value for each of the prediction modes in a second group (S42), wherein the prediction modes in the second group are the prediction modes with prediction directions near the two sides of the prediction direction of the prediction mode with smaller error value in the first group; calculating an error value for the prediction mode in a third group (S43), wherein the prediction mode in the third group is the prediction mode with prediction direction adjacent to the prediction direction of the prediction mode with smaller error value in the second group; calculating an error value for a DC prediction mode in the plurality of prediction modes (S44); and among the DC prediction mode, the prediction modes in the first group, the prediction modes in the second group, and the prediction mode in the third group, selecting a prediction mode with a smallest error value to be the intra prediction mode for encoding the subblock (S45). The calculating method for an error value mentioned above is to add up the absolute values of the differences between predicted values and original values of all the pixels in the subblock, wherein the predicted values are obtained by using specific prediction modes.

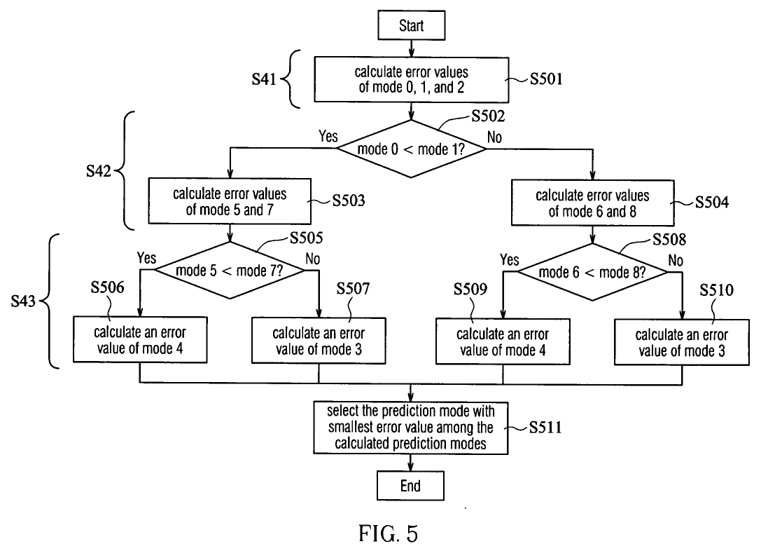

A video encoding method conforming to H.264/AVC video encoding standard is used as an example for describing how to select a preferred prediction mode. Referring to FIG. 5, the error values of mode 0, mode 1, and mode 2 are calculated first (S501), wherein mode 0 is the prediction mode of vertical direction and mode 1 is the prediction mode of horizontal direction. The included angle between the prediction directions of mode 0 and mode 1 is 90 degrees, which is the largest included angle between the prediction directions of any two of the eight prediction modes. Although the included angle between the prediction directions of mode 3 and mode 4 is also 90 degrees, the probability that mode 0 or mode 1 has the smallest error value is higher, and therefore the calculation of error values starts with mode 0 and mode 1. It is to be noted that the object of the invention can still be achieved if the calculation of error values starts with mode 3 and mode 4. Next step is to judge which of the error values of mode 0 and mode 1 is smaller (S502); if the error value of mode 0 is smaller, proceed to step S503, and if the error value of mode 1 is smaller, proceed to step S504.

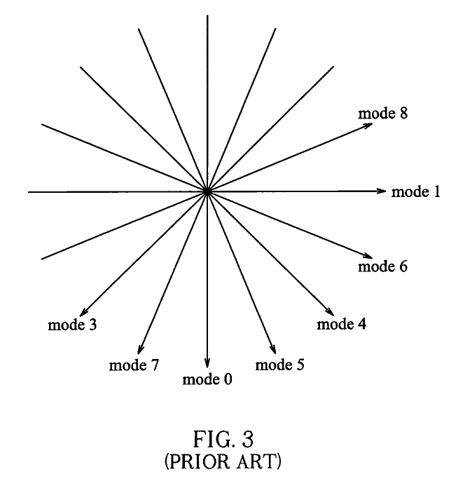

In step S503, the error values of mode 5 and mode 7 are calculated, and as shown in FIG. 3, the prediction directions of mode 5 and mode 7 are adjacent to the prediction direction of mode 0. The subsequent step is to judge which of the error values of mode 5 and mode 7 is smaller (S505); if the error value of mode 5 is smaller, proceed to step S506, and if the error value of mode 7 is smaller, proceed to step S507. In step S506, the error value of mode 4 is calculated, whereas in step S507, the error value of mode 3 is calculated; the prediction direction of mode 4 is adjacent to the prediction direction of mode 5, and the prediction direction of mode 3 is adjacent to the prediction direction of mode 7. Finally, the prediction mode with a smallest error value is selected among the prediction modes with calculated error values to be the intra prediction mode for encoding the subblock (S511).

Step S504 is to calculate the error values of mode 6 and mode 8, and as shown in FIG. 3, the prediction directions of mode 6 and mode 8 are adjacent to the prediction direction of mode 1. The subsequent step is to judge which of the error values of mode 6 and mode 8 is smaller (S508); if the error value of mode 6 is smaller, proceed to step S509, and if the error value of mode 8 is smaller, proceed to step S510. Step S509 is to calculate the error value of mode 4, whereas step S510 is to calculate the error value of mode 3; the prediction direction of mode 4 is adjacent to that of mode 6, and the prediction direction of mode 3 is adjacent to that of mode 8. Finally, among the prediction modes with calculated error values, the prediction mode with a smallest error value is selected to be the intra prediction mode for the subblock (S511).

In the aforementioned example, step S501 corresponds to step S41; steps S502 and S503 or steps S502 and S504 correspond to step S42; and steps S505 and S506, steps S505 and S507, steps S508 and S509, or steps S508 and S510 correspond to step S43. Moreover, the prediction modes in the first group are mode 0 and mode 1; the prediction modes in the second group are either mode 5 and mode 7, or mode 6 and mode 8, depending on the calculation results of the first group; and the prediction mode in the third group is either mode 3 or mode 4, depending on the calculation results of the second group. The aforementioned process shows that only the error values of six prediction modes need to be calculated to select a preferred prediction mode, rather than examining the error values of nine prediction modes. Take the process of steps S501, S502, S503, S505, S506 as an example, only the error values of modes 0, 1, 2, 5, 7, and 4 are calculated, and thus the calculation time for modes 3, 6, and 8 can be saved.

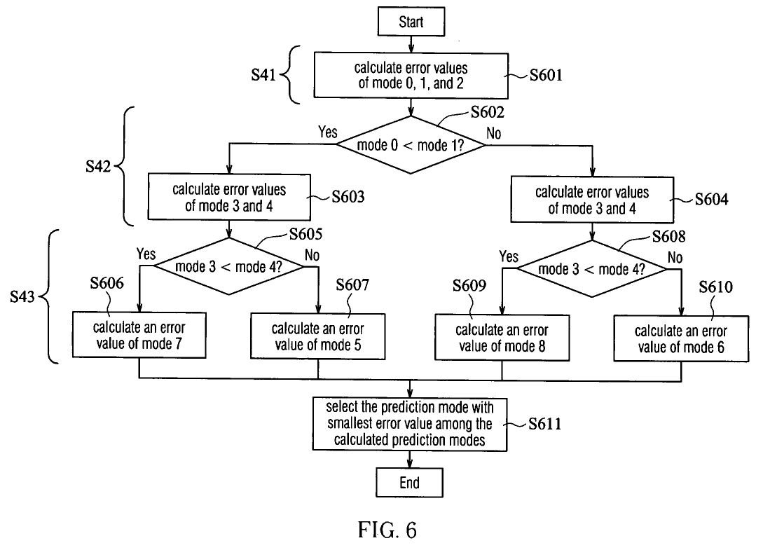

The video encoding method under H.264/AVC video encoding standard is used as an example to describe another method for selecting a preferred prediction mode. Referring to FIG. 6, the error values of mode 0, mode 1, and mode 2 are calculated first (S601). Next step is to judge which of the error values of mode 0 and mode 1 is smaller (S602); if the error value of mode 0 is smaller, proceed to step S603, and if the error value of mode 1 is smaller, proceed to step S604.

In step S603, the error values of mode 3 and mode 4 are calculated, and as shown in FIG. 3, the prediction directions of mode 3 and mode 4 are second adjacent to the prediction directions of mode 0 and mode 1. The subsequent step is to judge which of the error values of mode 3 and mode 4 is smaller (S605); if the error value of mode 3 is smaller, proceed to step S606, and if the error value of mode 4 is smaller, proceed to step S607. Step S606 is to calculate the error value of mode 7 and step S607 is to calculate the error value of mode 5, wherein the prediction direction of mode 7 is between the prediction directions of mode 0 and mode 3, and the prediction direction of mode 5 is between the prediction directions of mode 0 and mode 4. Finally, among the prediction modes with calculated error values, select a prediction mode having a smallest error value to be the intra prediction mode for encoding the subblock (S611).

Step S604 is also to calculate the error values of mode 3 and mode 4, and the step thereafter is to judge which of the error values of mode 3 and mode 4 is smaller (S608); if the error value of mode 3 is smaller, proceed to step S609, and if the error value of mode 4 is smaller, proceed to step S610. In step S609, the error value of mode 8 is calculated, whereas in step S610, the error value of mode 6 is calculated; the prediction direction of mode 8 is between that of mode 1 and mode 3, and the prediction direction of mode 6 is between that of mode 1 and mode 4. Finally, among the prediction modes that have their error values calculated, the prediction mode with a smallest error value is selected to be the intra prediction mode for encoding the subblock (S611).

In the aforementioned example, step S601 corresponds to step S41; steps S602 and S603, or steps S602 and S604 correspond to step S42; and steps S605 and S606, steps S605 and S607, steps S608 and S609, or steps S608 and S610 correspond to step S43. Moreover, the prediction modes in the first group are mode 0 and mode 1; the prediction modes in the second group are mode 3 and mode 4; and the prediction mode in the third group is one of mode 5, mode 6, mode 7, and mode 8, depending on the calculation results of the second group. The aforementioned process shows that, for selecting a preferred prediction mode, only the error values of six prediction modes need to be calculated. Take the process of steps S601, S602, S603, S605, and S606 as an example, only the error values of modes 0, 1, 2, 3, 4, and 7 need to be calculated, and thus the calculation time of modes 5, 6, and 8 can be saved.

It is to be noted that although the aforementioned mode 2 (the DC prediction mode) is calculated along with the prediction modes in the first group, it can also be calculated independently or along with the prediction modes in the second group, the prediction mode in the third group. The error value calculation of the DC prediction mode does not relate in context with the error value calculations of the prediction modes in the first group, the second group, and the third group, and so a person skilled in the art may alter the calculation sequence thereof according to requirement.

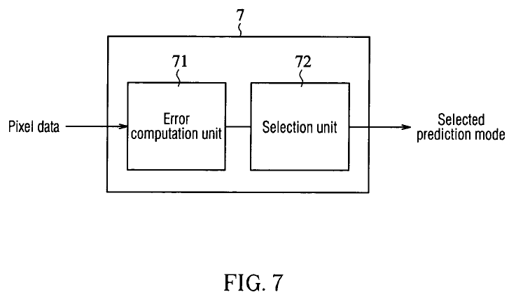

Referring to FIG. 7, an apparatus 7 for selecting intra prediction mode according to a preferred embodiment of the invention is for executing the aforementioned method for selecting intra prediction mode. The apparatus 7 for selecting intra prediction mode includes an error computation unit 71 and a selection unit 72. The error computation unit 71 accepts data of reference pixels and calculates an error value for each of the prediction modes in a first group first, an error value for each of the prediction modes in a second group second, and then an error value for the prediction mode in a third group. The first group includes two prediction modes which have an included angle between their prediction directions that is the largest, the prediction modes in the second group refer to the prediction modes with prediction directions near the two sides of the prediction direction of the prediction mode with smaller error value in the first group, and the prediction mode in the third group refers to the prediction mode with prediction direction adjacent to the prediction direction of the prediction mode with smaller error value in the second group. Also, the error computation unit 71 calculates an error value for a DC prediction mode in a plurality of prediction modes. The selection unit 72 is connected to the error computation unit 71 via signals, and according to the computation results of the error computation unit 71, selects among the DC prediction mode, the prediction modes in the first group, the prediction modes in the second group, and the prediction mode in the third group, a prediction mode with a smallest error value to be the intra prediction mode for encoding the subblock.

According to the method and apparatus for selecting intra prediction mode of the invention, a preferred prediction mode for a single subblock can be selected by calculating only six error values. Comparing to the conventional technology, which needs to calculate nine error values to select a preferred prediction mode, the invention can effectively reduce the number of computations and lower the computation load. By comparing the picture quality of the encoded video frames, similar peak signal to noise ratios are obtained, which means that the picture quality of frames encoded by the method and apparatus for selecting intra prediction mode of the invention is close to the picture quality of frames encoded by conventional optimization.

While the invention has been described by way of example and in terms of the preferred embodiment, it is to be understood that the invention is not limited to the disclosed embodiments. In other words, it is intended to include equivalent modifications and changes of the above embodiments without departing from the spirit and scope of the invention as would be apparent to those skilled in the art. For example, the video encoding method under H.264/AVC standard takes a subblock composed of 4×4 pixels as a unit to calculate the error value, but those skilled in the art can take subblocks composed of 8×8 or 16×16 pixels as a unit to calculate the error value of a specific prediction mode. Therefore, the scope of the appended claims should be accorded the broadest interpretation so as to encompass all such equivalent modifications and changes.

What is claimed is:

1. A method for selecting intra prediction mode, which is applied in a video encoding method that encodes a video data stream and defines a plurality of prediction modes, wherein the video data includes a plurality of video frame streams and the video frame is composed of a plurality of subblocks, the method comprising:
calculating an error value for each of the prediction modes in a first group, the first group including two prediction modes where an included angle between their prediction directions is the largest and the included angle refers to the smaller one of the two complementary included angles;
calculating an error value for each of the prediction modes in a second group, wherein the prediction modes in the second group are the prediction modes with prediction directions near the two sides of the prediction direction of the prediction mode with smaller error value in the first group;
calculating an error value for the prediction mode in a third group, wherein the prediction mode in the third group is the prediction mode with prediction direction adjacent to the prediction direction of the prediction mode with smaller error value in the second group;
calculating an error value for a DC prediction mode in the plurality of prediction modes; and
among the DC prediction mode, the prediction modes in the first group, the prediction modes in the second group, and the prediction mode in the third group, selecting a prediction mode with a smallest error value to be the intra prediction mode for encoding the subblock.

2. The method for selecting intra prediction mode as described in claim 1, wherein the plurality of prediction modes comprise a vertical prediction mode, a horizontal prediction mode, and six diagonal prediction modes.

3. The method for selecting intra prediction mode as described in claim 2, wherein the prediction modes in the first group are the vertical prediction mode and the horizontal prediction mode.

4. The method for selecting intra prediction mode as described in claim 3, wherein the prediction modes in the second group are the prediction modes adjacent to the two sides of the vertical prediction mode, or the prediction modes adjacent to the two sides of the horizontal prediction mode.

5. The method for selecting intra prediction mode as described in claim 4, wherein the prediction mode in the third group is a prediction mode not included in the first group.

6. The method for selecting intra prediction mode as described in claim 3, wherein the prediction modes in the second group are the prediction modes second adjacent to the vertical prediction mode or the horizontal prediction mode.

7. The method for selecting intra prediction mode as described in claim 6, wherein the prediction mode in the third group is the prediction mode between the prediction mode with smaller error value in the first group and the prediction mode with smaller error value in the second group.

8. The method for selecting intra prediction mode as described in claim 1, wherein the error value is the sum of absolute values of differences between predicted values and original values of all the pixels in the subblock.

9. The method for selecting intra prediction mode as described in claim 8, wherein the subblock is composed of 4×4, 8×8, or 16×16 pixels.

10. The method for selecting intra prediction mode as described in claim 1, wherein the video encoding method conforms to H.264/AVC video encoding standard.

11. An apparatus for selecting intra prediction mode, which is applied in a video encoding system that encodes a video data stream and defines a plurality of prediction modes, wherein the video data includes a plurality of video frame streams and the video frame is composed of a plurality of subblocks, the apparatus comprising:
an error computation unit, for calculating an error value for a DC prediction mode in the plurality of prediction modes, an error value for each of the prediction modes in a first group, an error value for each of the prediction modes in a second group, and an error value for the prediction mode in a third group, wherein the first group includes two prediction modes where an included angle between their prediction directions is the largest and the included angle refers to the smaller one of the two complementary included angles, the prediction modes in the second group are the prediction modes with prediction directions near the two sides of the prediction direction of the prediction mode with smaller error value in the first group, and the prediction mode in the third group is the prediction mode with prediction direction adjacent to the prediction direction of the prediction mode with smaller error value in the second group; and
a selection unit, which is connected to the error computation unit via signals and, according to the computation results of the error computation unit, selects a prediction mode with a smallest error value among the DC prediction mode, the prediction modes in the first group, the prediction modes in the second group, and the prediction mode in the third group, to be the intra prediction mode for encoding the subblock.

12. The apparatus for selecting intra prediction mode as described in claim 11, wherein the plurality of prediction modes comprise a vertical prediction mode, a horizontal prediction mode, and six diagonal prediction modes.

13. The apparatus for selecting intra prediction mode as described in claim 12, wherein the prediction modes in the first group are the vertical prediction mode and the horizontal prediction mode.

14. The apparatus for selecting intra prediction mode as described in claim 13, wherein the prediction modes in the second group are the prediction modes adjacent to the two sides of the vertical prediction mode, or the prediction modes adjacent to the two sides of the horizontal prediction mode.

15. The apparatus for selecting intra prediction mode as described in claim 14, wherein the prediction mode in the third group is a prediction mode not included in the first group.

16. The apparatus for selecting intra prediction mode as described in claim 13, wherein the prediction modes in the second group are the prediction modes second adjacent to the vertical prediction mode or the horizontal prediction mode.

17. The apparatus for selecting intra prediction mode as described in claim 16, wherein the prediction mode in the third group is the prediction mode between the prediction mode with smaller error value in the first group and the prediction mode with smaller error value in the second group.

18. The apparatus for selecting intra prediction mode as described in claim 11, wherein the error value is the sum of absolute values of differences between predicted values and original values of all pixels in the subblock.

19. The apparatus for selecting intra prediction mode as described in claim 18, wherein the subblock is composed of 4×4, 8×8, or 16×16 pixels.

20. The apparatus for selecting intra prediction mode as described in claim 11, wherein the video encoding method conforms to H.264/AVC video encoding standard.
